(19) United States
(12) Patent Application Publication
(10) Pub. No.: US 2022/0316623 A1
(43) Pub. Date: Oct. 6, 2022

(54) PIPE CLIP

(71) Applicant: Talon Manufacturing Limited, Kent (GB)

(72) Inventor: Ian Roy Newton, Kent (GB)

(21) Appl. No.: 17/616,778

(22) PCT Filed: Jun. 23, 2020
(86) PCT No.: PCT/EP2020/067524

§ 371 Date: Dec. 6, 2021

(30) Foreign Application Priority Data
Jun. 25, 2019 (GB) 1909107.3

(51) Int. Cl. F16L 3/13; F16L 3/22

(52) U.S. Cl. CPC F16L 3/13; F16L 3/222

(57) ABSTRACT

A pipe clip operable to be fixed to a mounting position, typically a joist, comprising a pipe receiving portion and a mounting portion connected by a base portion, the base portion configured to allow the pipe clip to be seated on the mounting position.

### CROSS-REFERENCE TO RELATED APPLICATIONS

This Application is a National Stage Application under 35 U.S.C. § 371 of PCT Application No. PCT/EP2020/067524, filed Jun. 23, 2020, which claims priority to British Patent Application No. 1909107.3, filed Jun. 25, 2019, the entire contents of which are incorporated by reference herein.

### FIELD OF THE INVENTION

The present invention relates to a pipe clip. It is particularly, although not exclusively, relevant to a pipe clip for securing a pipe to a supporting member, such as a joist.

### BACKGROUND

Pipe clips are well known in the art. Pipe clips generally include a lower portion with an aperture for fastening the pipe clip with a nail or screw, and an upper portion with resilient pipe receiving means into which the pipe is secured into place.

An example of a pipe clip is shown in GB2485844. This arrangement has a lower portion that extends such that the clip may be fixed to the side of a joust. However, it is disadvantageous in that it is fiddly to attach, requiring the fitter to hold the clip in position, as well as handle the nail or screw and the hammer or screw driver. This is particularly difficult when space is limited.

The arrangement of GB2485844 is also disadvantageous in that it needs to be held in place whilst, for example, measurements or the like are made.

It is an objection of the present invention to provide a pipe clip which substantially overcomes these problems.

### SUMMARY OF THE INVENTION

According to a first aspect of the present invention there is provided a pipe clip operable to be fixed to a mounting position, the pipe clip comprising a pipe receiving portion and a mounting portion connected by a base portion, the base portion configured to allow the pipe clip to be seated on the mounting position.

Typically the mounting position would be a joist or beam.

It is preferred that the centre of gravity of the pipe clip is over the beam or joist when the clip is positioned for use no top of the joist or beam.

Preferably the mounting portion overhangs the joist.

Preferably the mounting portion and the base portion form a right angle that allows the pipe clip to be placed over a corner of the joist. In such an arrangement it is preferred that the entirety of the pipe receiving portion is maintained over the joist. In such an arrangement the pipe clip, when viewed from the side, may take the shape of a zig-zag.

Preferably the mounting portion comprises an aperture to allow fixing means (such as a nail or a screw) to secure the pipe clip to a beam or joist. Additional apertures may be provided. However, given that the pipe clip is seated on the joist, a single nail or screw is typically sufficient to hold the pipe clip in position. Alternatively, an adhesive may be used.

According to a second aspect of the present invention there is provided a pipe clip comprising a pipe receiving portion and a mounting portion, wherein the pipe receiving portion and the mounting portion are offset with one another along the axis defined by the pipe.

Preferably the pipe receiving portion and the mounting portion are connected by a base portion. It is preferred that the base portion substantially forms a right angle with the mounting portion. It is further preferred that the base portion forms a right angle with the pipe receiving portion.

The base portion and the mounting portion may cooperate with a corner of a beam, joist or other mounting surface. The mounting portion may comprise means, such as an aperture, to allow means, such as a nail or screw, to affix the pipe clip to the mounting surface. Alternatively, means such as adhesive may be used. Appropriate adhesive pads may be provided on one or other or both of the base portion or the mounting portion.

The base portion may incorporate gripping means. Such gripping means may be one or a plurality of spikes or other such protrusions. Alternatively a textured surface may be provided.

According to a third aspect of the present invention there is provided a pipe clip operable to be mounted onto the top of a beam, the pipe clip comprising a pipe receiving portion and a mounting portion wherein the centre of gravity of the pipe clip is maintained over the beam, and wherein the mounting portion at least partially overhangs the beam.

It is preferred that the entirety of the pipe receiving portion is maintained over the beam, when said pipe clip is mounted on the top of said beam.

Preferably the pipe receiving section is heavier than the mounting portion. This may be achieved by differing sizes, differing weights (including through the use of materials with differing densities) or the addition of further material. Said further material may be a different material from that used to fabricate the pipe receiving portion.

It is preferred that the pipe clip comprises means to allow said pipe clip to be seated on a mounting position. Preferably said means is a base portion operable to permit the pipe clip to rest on the top of a mounting position.

It is preferred, in all aspects of the invention that the pipe clip is fabricated from plastic.

Preferred features for all aspects are compatible with, and interchangeable with, each other.

In order that the present invention be more readily understood, specific embodiments thereof will now be described with reference to the accompanying drawings.

### DESCRIPTION OF THE DRAWINGS

FIG. 1 shows a front view of a pipe clip in accordance with an embodiment of the present invention

FIG. 2 shows a top view of the pipe clip of FIG. 1.

FIG. 3 shows a side view of the pipe clip of FIG. 1.

FIG. 4a shows a perspective view of a pipe clip in an orientation to receive a pipe.

FIG. 4b shows the pipe clip of FIG. 4a in an orientation to secure a pipe.

FIG. 5 shows the pipe of FIGS. 4a and 4b with a pipe in situ.

FIG. 6 shows a pipe clip retaining a pipe against a joust.

FIG. 7 shows a pair of pipe clips retaining a pipe against a joust.

FIG. 8 shows a pair of pipes being retained by a pair of pipe clips.

### DESCRIPTION OF EMBODIMENTS

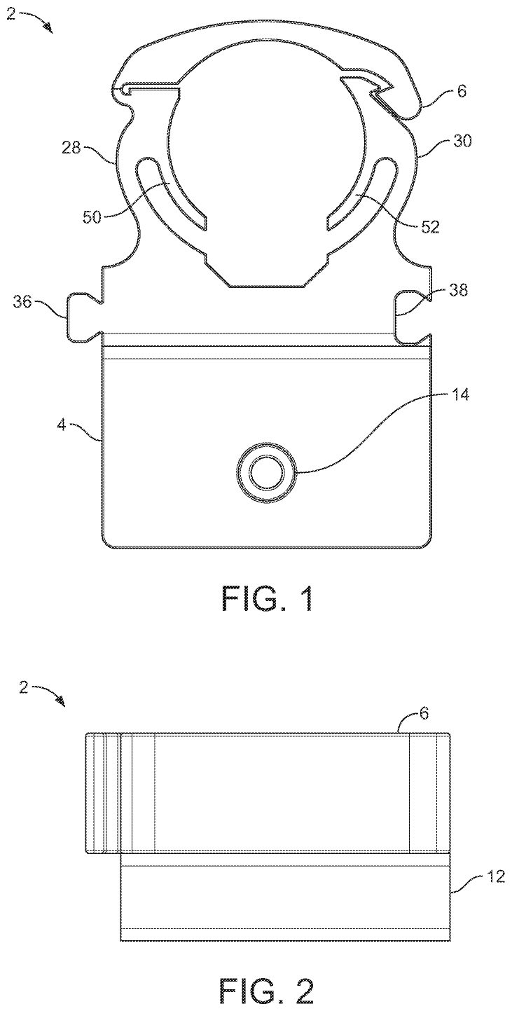

FIGS. 1 to 3 show a pipe clip 2 in accordance with an embodiment of the present invention. The pipe clip 2 comprises a pipe retaining portion 6 and a mounting portion 4. The pipe retaining portion 6 and the mounting portion are connected by base portion 12.

The mounting portion 4 comprises an aperture 14 to allow the pipe clip to be secured to a joist be a screw or nail. It will be appreciated that a plurality of apertures may be provided. The number of apertures provided will, to a greater or lesser extent, be determined by the size of the clip and the size of the pipe to be retained.

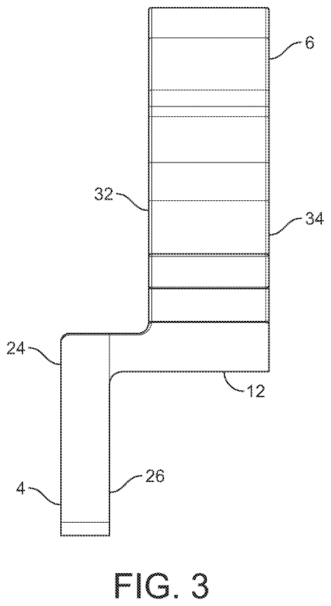

FIG. 1 shows the pipe clip 2 from the front. FIG. 2 shows the pipe clip 2 from the top, whilst FIG. 3 shows the pipe clip 2 from the side (being the right-hand side of the clip shown in FIG. 1). As will be appreciated from, particularly, FIGS. 2 and 3, the base portion 12 causes the pipe retaining portion 6 and the mounting portion 4 to be offset with respect to one another in a direction parallel to the primary axis of the pipe to be retained. The arrangement may be likened to a zig-zag shape.

The provision of the base portion 12 allows the pipe clip 2 to be seated on a joist. The centre of gravity of the pipe clip is maintained over the joist. The pipe clip will remain on the joist without needing to be nailed or screwed into position. Accordingly, the pipe clip 2 can be placed in position, where it will remain, whilst measurements are made. Further, the pipe clip will remain in position without the need to hold it in place, allowing the fitter to handle a nail or screw in one hand, and a hammer, screwdriver or impact driver in the other.

In use, the mounting portion 4 overhangs the joist. Such an arrangement allows for ease of fitting of the pipe clip 2 to a mounting surface.

The base portion 12 and the mounting portion 4 form a substantially 90 degree angle, allowing the pipe clip 2 to cooperate with a corner of a joist beam. Fixing means 16 may then be inserted through aperture 14 to fix the clip to the joist. This arrangement is shown in FIG. 6. The mounting portion comprises a front face 24 and a back face 26. In use, the back face 26 sits against the joist. The fixing means (e.g. a screw) is inserted through aperture 14 in the front face 24, and finishes flush thereto.

The pipe receiving portion may also been defined as having a notional front face 32 and a notional back face 34.

As viewed in FIG. 3, the mounting portion is offset from the pipe receiving portion along the axis parallel to the pipe to be secured. To ensure that the pipe clip may be securely seated on the joist, it is preferred that the back face 26 of mounting portion 4 extends further forward than the front face 32 of pipe receiving portion 6. Put another way, it could be defined that the base portion 12 has a greater width that the pipe receiving portion 6.

Such an arrangement allows for the centre of gravity of the pipe clip 2 to be maintained over a beam or joist when the pipe clip 2 is seated thereon. Additionally, the entirety of the pipe retaining portion 6 is maintained over the joist or beam.

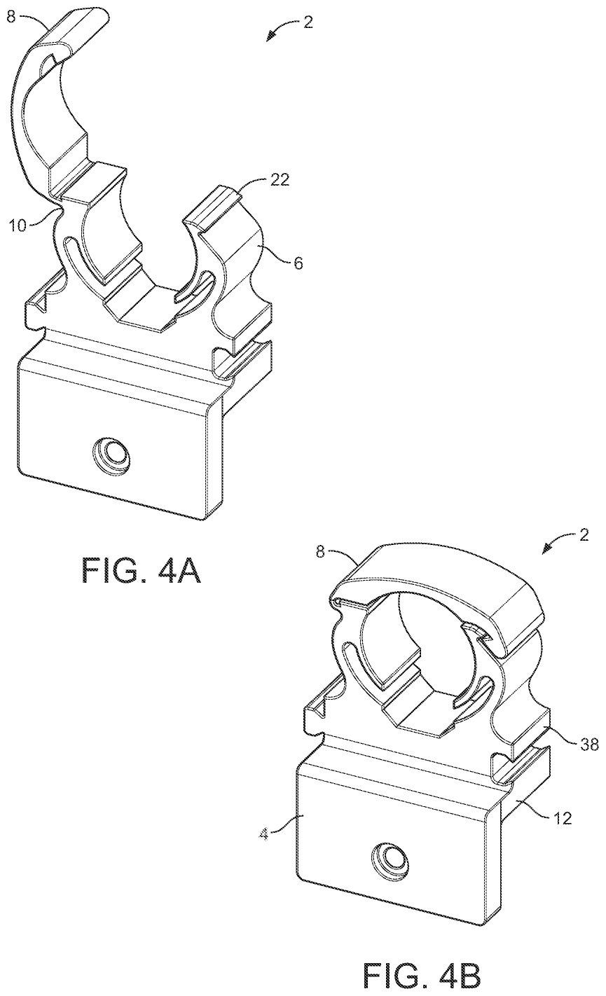

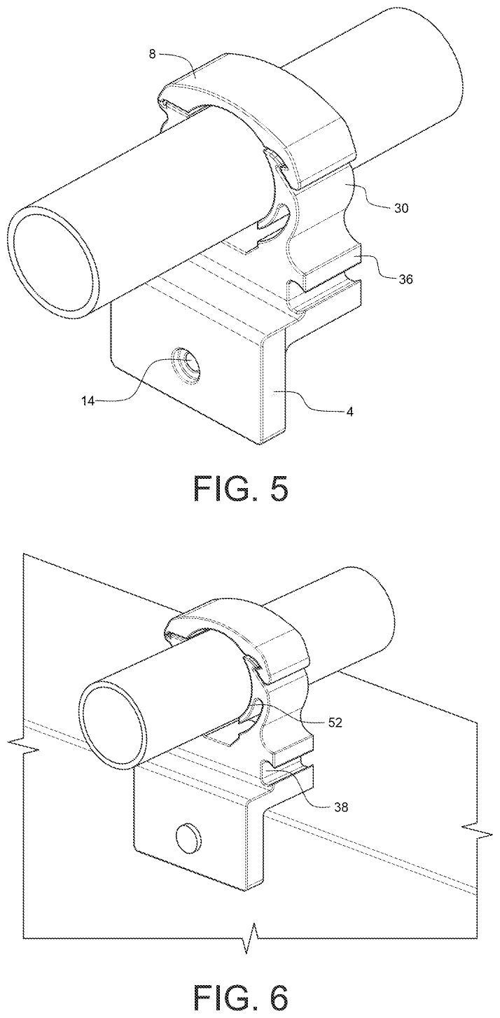

FIGS. 4a and 4b show the pipe receiving portion 6 in operation. An arm 8 is pivotally mounted at hinge 10. The end of the arm 8 remote from hinge 10 may engage with catch 22. The arm 8 may have a lip or hook to better engage with catch 22. The arm 8 is shown in an open position in FIG. 4a, and in a closed position in FIG. 4b.

It will be appreciated that the arm 8 is optional, and that the arrangement would adequately function with a pair of curved retaining arms. However, the locking arm 8 is preferred to give a more secure fastening.

The side portions of the pipe receiving portion comprise a pair of resilient curved arms 28, 30 extending from the base portion 12. The curved arms are resilient and flex radially outwards when a pipe is being fitted thereto. Once the arms 28, 30 have extended over the maximum diameter of the pipe they flex back into their original position to secure the pipe.

Additional gripping arms 50, 52 may be provided. Said arms 50, 52 are provided in the inner area of the pipe retaining portion 6. Such means allows for the pipe clip 2 to better retain a pipe.

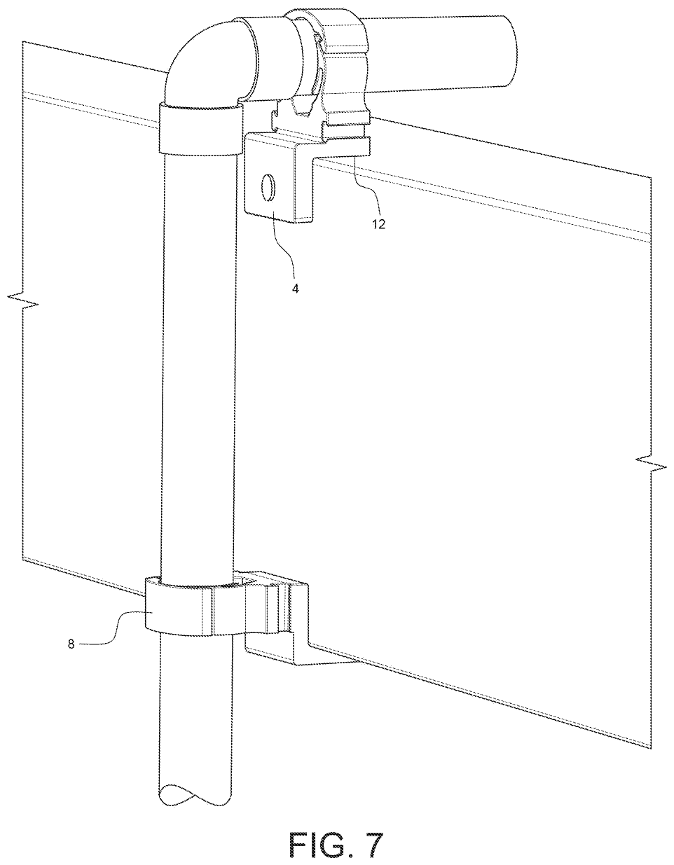

FIGS. 6 and 7 show an embodiment of the pipe clip in use. As will be appreciate from FIG. 7, the present pipe clip 2 may be utilized in different orientations. Advantages of the present arrangement can still be realised if the pipe clip 2 is mounted with an adhesive. In any event, providing a significant mounting area using a base portion and a mounting portion according to the present arrangement provides a stable anchor point for the pipe to be attached to a joist.

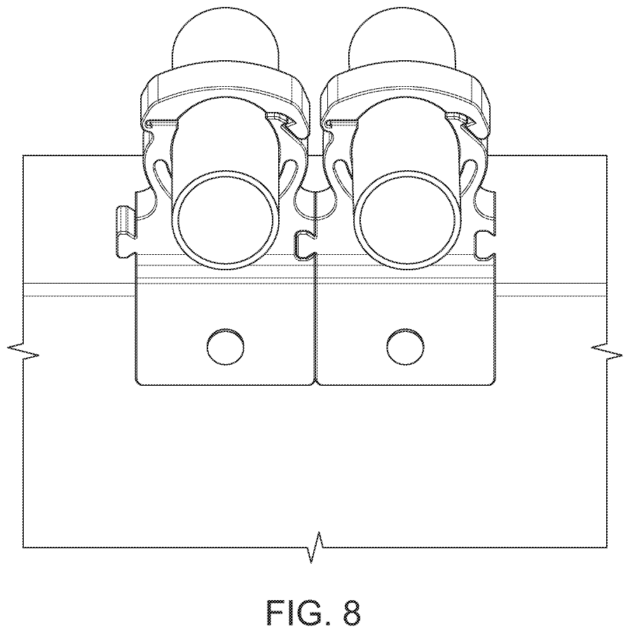

The pipe clip 2 may comprise means 36, 38 to allow a plurality of such pipe clips to be connected together. Such means may comprise a recess 38 disposed in a first side of the clip and a protrusion 36 extending laterally from a second side of the clip. The protrusion is shaped to fit within the recess 38. The drawings show the protrusion 36 and the recess 38 to be T-shaped. However, any other suitable corresponding and lockable forms may be used. FIG. 8 shows an example of a pair of pipe clips engaged together.

It is preferred that the pipe clip is manufactured exclusively or substantially from plastic.

The present arrangement is straightforward to install, and may be retrofitted into existing structures. The present pipe clip saves time when being installing pipe work to joists and beams.

A further modification (not shown) would be to have a mounting portion 4 and a pipe retaining portion 6 as a continuous planar surface, with the base portion 12 extending perpendicularly outwards from substantially the middle of said planar surface. A pipe clip 2 of this configuration could be considered as a T-shape. In use, the pipe clip 2 would be rotated through 90 degrees, such that the foot of the T sat on the joist. The mounting portion 4 would overhang the joist and form a right angle with the base portion 12. The pipe retaining portion would extend above the joist to receive the pipe.

In such as arrangement the base section 12 would be sufficiently heavy relative to the mounting portion and the pipe retaining portion that the clip would remain seated on a joist. The weight of the base section would be sufficient to ensure that the centre of gravity of the pipe clip 2 would remain over the joist.

It is to be appreciated that many modifications to the above are possible within the scope of the appended claims.

1. A pipe clip operable to be fixed to a mounting position, the pipe clip comprising a pipe receiving portion and a mounting portion connected by a base portion, the base portion configured to allow the pipe clip to be seated on the mounting position.

2. The pipe clip according to claim 1, wherein the centre of gravity of the pipe clip is over the mounting position when the clip is positioned for use.

3. The pipe clip according to claim 1, wherein the mounting portion overhangs the mounting position.

4. The pipe clip according to claim 1, wherein the mounting portion and the base portion form a right angle.

5. The pipe clip according to claim 1, wherein the mounting portion comprises an aperture to allow fixing means to secure the pipe clip to the mounting position.

6. A pipe clip comprising a pipe receiving portion and a mounting portion, wherein the pipe receiving portion and the mounting portion are offset with one another along an axis defined by the pipe.

7. The pipe clip according to claim 6, wherein the pipe receiving portion and the mounting portion are connected by a base portion.

8. The pipe clip according to claim 7, wherein the base portion substantially forms a right angle with the mounting portion.

9. The pipe clip according to claim 7, wherein the base portion forms a right angle with the pipe receiving portion.

10. A pipe clip operable to be mounted onto the top of a beam, the pipe clip comprising a pipe receiving portion and a mounting portion wherein the centre of gravity of the pipe clip is maintained over the beam, and wherein the mounting portion at least partially overhangs the beam.

11. The pipe clip according to claim 10, wherein the entirety of the pipe receiving portion is maintained over the beam, when said pipe clip is mounted on the top of said beam.

12. The pipe clip according to any preceding claim 1, wherein the pipe clip is fabricated from plastic.

13. The pipe clip according to claim 6, wherein the pipe clip is fabricated from plastic.

14. The pipe clip according to claim 10, wherein the pipe clip is fabricated from plastic.

15. The pipe clip according to claim 2, wherein the mounting portion overhangs the mounting position.

16. The pipe clip according to claim 15, wherein the mounting portion and the base portion form a right angle.

17. The pipe clip according to claim 2, wherein the mounting portion and the base portion form a right angle.

18. The pipe clip according to claim 3, wherein the mounting portion and the base portion form a right angle.

19. The pipe clip according to claim 8, wherein the base portion forms a right angle with the pipe receiving portion.
